(19) United States
(12) Patent Application Publication
(10) Pub. No.: US 2022/0387970 A1
(43) Pub. Date: Dec. 8, 2022

(54) MXene-DERIVED METAL-ORGANIC FRAMEWORKS AND METHOD

(71) Applicant: KING ABDULLAH UNIVERSITY OF SCIENCE AND TECHNOLOGY, Thuwal (SA)

(72) Inventors: Hao WU, Thuwal (SA); Osama SHEKHAH, Thuwal (SA); Mohamed EDDAOUDI, Thuwal (SA); Husam Niman ALSHAREEF, Garland, TX (US)

(21) Appl. No.: 17/771,267

(22) PCT Filed: Oct. 23, 2020
(86) PCT No.: PCT/IB2020/060000

§ 371 Date: Apr. 22, 2022

Related U.S. Application Data
(60) Provisional application No. 62/930,043, filed on Nov. 4, 2019.

(51) Int. Cl. B01J 20/22; B01J 20/28; B01J 20/32; H01G 11/56; C25B 3/26; C25B 9/21

(52) U.S. Cl. CPC B01J 20/226; B01J 20/28007; B01J 20/3242; B01J 20/3236; H01G 11/56; C25B 3/26; C25B 9/21

(57) ABSTRACT

A method for making a metal-organic framework, MOF, as nanosheets, includes providing a MXene, wherein the MXene has a general formula of Mₙ₊₁XₙTₓ, with n=1-3, M represents an early transition metal, X is C and/or N, and Tx is surface terminations; providing a ligand; mixing the MXene and the ligand in a vessel; heating the MXene and the ligand in the vessel; and forming the MX-MOF nanosheets. The MX-MOF nanosheets have a thickness less than 10 nm.

### CROSS-REFERENCE TO RELATED APPLICATIONS

This application claims priority to U.S. Provisional Patent Application No. 62/930,043, filed on Nov. 4, 2019, entitled “MXENE-DERIVED METAL-ORGANIC FRAMEWORKS AND THEIR APPLICATION IN ELECTROCATALYTIC CO2 REDUCTION,” the disclosure of which is incorporated herein by reference in its entirety.

### BACKGROUND

### Technical Field

Embodiments of the subject matter disclosed herein generally relate to a metal-organic framework and method for making the same, and more particularly, to a MXene based metal-organic framework and various applications of such a compound.

### Discussion of the Background

Metal-organic frameworks (MOFs) have attracted enormous attention in various research fields such as gas storage/separation, sensing, catalysis, etc., due to their advantageous porosity, large surface area, and numerous structural and chemical tunability. However, manipulating conventional bulk MOFs into 2D nanosheets and thin-film form is very challenging, although extremely desired. Having the MOFs manufactured as 2D nanosheets and thin-films advantageously enables new applications in electronics, sensors, and other device applications. In pursuit of such MOF thin films, layer-by-layer and Langmuir-Blodgett techniques have been developed [1-3] for growing the MOF as thin films. However, these protocols require specific surface topologies and/or interfaces, specialized equipment, and skilled multistep operations, which severely restrict the large-scale practical applications [4-7].

Alternatively, tailoring the MOFs themselves into the nanoscale films with controlled growth dimensionalities (e.g., two dimensional, 2D) and architectures are highly desirable as they could meet the specific requirements in the various areas where such MOFs are desired, beyond the bulk MOFs.

In general, MOFs are generated by coordination reactions between soluble inorganic metal salts (e.g., nitrates, chlorides, and acetates) and organic ligands in polar solvents. However, using conventional MOF synthesis methods, one typically has little control over the generation process of the MOFs in terms of the desired dimensionality of such compounds. In pursuit of the well-defined geometrical shape of the MOF crystals, eco-friendly and cost-effective insoluble metal precursors (e.g., metals, metal oxides/hydroxides) have been developed. Among them, some are used as hard templates while some serve simultaneously as sacrificial templates where the parental features could be readily inherited. Yet, the wide utilization of the hard template approach is restricted due to the fact that the precursors are normally anchored to various substrates. In addition, the incomplete conversion of the metal residuals has been observed, leading to inseparable MOF/metal composite species.

Recently, Moran (Moran, C. M.; Joshi, J. N.; Marti, R. M.; Hayes, S. E.; Walton, K. S. Structured Growth of Metal-Organic Framework MIL-53(Al) from Solid Aluminum Carbide Precursor. J. Am. Chem. Soc. 2018, 140, 9148-9153) has demonstrated an insoluble metal carbide (Al₄C₃) precursor that was used to prepare needle-like MIL-53 (Al) MOF crystals. However, the low surface area of the bulk precursor provided limited accessible sites to spatially control the nucleation to form mesoscopic architectures.

Therefore, the existing methods for synthesizing nanoscale MOFs is a highly challenging task because the conventional soluble metal salt precursors are not easy to be manipulated spatially, thus normally leading to bulk MOFs.

Thus, there is a need for a new compound and method for forming the compound so that MOFs with desired shapes and morphologies can be mass produced in industrial settings, without the required highly specialized equipment or fabrication steps.

### BRIEF SUMMARY OF THE INVENTION

According to an embodiment, there is a method for making a metal-organic framework, MOF, as nanosheets. The method includes providing a MXene, where the MXene has a general formula of Mₙ₊₁XₙTₓ, with n=1-3, M represents an early transition metal, X is C and/or N, and Tx is surface terminations, providing a ligand, mixing the MXene and the ligand in a vessel, heating the MXene and the ligand in the vessel, and forming the MX-MOF nanosheets. The MX-MOF nanosheets have a thickness less than 10 nm.

According to another embodiment, there is an electrochemical cell that includes a housing, an anode located inside the housing, a cathode located inside the housing, and a solid state electrolyte located between the anode and cathode, the solid state electrolyte including a MXene based metal-organic framework, MX-MOF, film. The MX-MOF film includes parallel distributed MX-MOF nanosheets.

According to still another embodiment, there is a transistor that includes a substrate, a semiconductor layer formed on the substrate and patterned to form a source S, a drain D, and a gate G; a MXene based metal-organic framework, MX-MOF, film formed over the source S, drain D, and gate G, and an encapsulation layer formed over the MX-MOF film to confine an ionic transport environment within the MX-MOF film.

### BRIEF DESCRIPTION OF THE DRAWINGS

For a more complete understanding of the present invention, reference is now made to the following descriptions taken in conjunction with the accompanying drawings, in which:

FIG. 1A illustrates the chemical structure of a MXene precursor, FIG. 1B illustrates a multilayered MXene obtained from the precursor shown in FIG. 1A, and FIG. 1C illustrates the delaminated MXene;

FIG. 2 schematically illustrates the MXene and a ligand being mixed together;

FIG. 3 illustrates the reactions taken place between the MXene and the ligand that make these two components to stay together;

FIGS. 4A and 4B illustrate the atomic composition and structure of the MOF nanosheets obtained from the MXene;

FIG. 5 illustrates a MOF thin film obtained from the MOF nanosheets;

FIG. 6 shows the X-ray diffraction patterns of the MXene;

FIG. 7 shows the X-ray photoelectron spectroscopy spectrum of the MXene;

FIG. 8 shows the X-ray diffraction patterns of MOFs derived from various precursors;

FIG. 9 illustrates the N₂ isotherm of the MXene based MOF and a known MOF;

FIG. 10 illustrates a scanning electron microscope (SEM) image of a MXene based MOF thin film;

FIGS. 11A and 11B illustrate the height profiles of the MXene based MOFs at various temperatures;

FIG. 12 illustrates the bonds of MXene (V—C and V—F) have disappeared, while the aromatic C═C and C—O bonds originating from the ligand became dominant as the MOF is created;

FIG. 13 illustrates the X-ray photoelectron spectroscopy spectrum of the MXene based MOF;

FIG. 14 illustrates the UV-vis spectroscopy of the MXene based MOF and a known MOF;

FIG. 15 illustrates the UV-vis transmittance of the MXene based MOF thin films;

FIG. 16 illustrates the X-ray photoelectron spectroscopy pattern of the MXene based MOF thin film and the diffraction results along the (011) direction;

FIG. 17 illustrates the Nynquist plot for the acid-doped MXene based MOF thin film;

FIG. 18 illustrates an electrochemical cell that uses the MXene based MOF thin film as a solid state electrolyte;

FIGS. 19A to 19F illustrate the process of making a transistor that uses the MXene based MOF thin film as a dielectric material; and

FIG. 20 is a flow chart of a method for making the MXene based MOF thin film.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a V₂CTₓ MXene precursor for forming the nanoscale MOF sheets. However, the embodiments to be discussed next are not limited to this specific MXene, but other MXene members may be used for forming the desired nanoscale MOF sheets.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a MXene is used as a metal precursor to fabricate two dimensional (2D) MOF nanosheets, whose thickness (6 to 18 nm) can be tuned by varying a reaction temperature. The highly electronegative surface atoms of the MXene compound and sufficient accessible attacking sites for ligands are responsible for the evolution of the 2D MOF nanosheets. Moreover, highly oriented and smooth MOF thin films have been grown based on these nanosheets using a convenient spin coating process. With impregnation of nonvolatile H₃PO₄, the MOF thin film exhibits proton-conducting properties at 25° C. The embodiments discussed next demonstrate that the high-quality 2D MOF sheets and thin films are enabled by the 2D MXene precursors.

MXenes are an emerging group of 2D laminated inorganic transition metal carbides, nitrides, or carbonitrides with a general formula of Mₙ₊₁XₙTₓ, with n=1-3, where M represents early transition metals (e.g., Ti, V, etc.), X is C and/or N, and Tₓ is surface terminations (—F, —O and —OH). To date, over 30 MXenes with wide chemical and structural varieties have been synthesized. It is noteworthy that the terminal atoms on the surface of the MXene, having low work function and high electronegativity, enable them to be strong electron acceptors, which is beneficial for the deprotonation of organic ligands and thus the subsequent bridging with the underlying metal atoms. Meanwhile, the sufficiently accessible surfaces of the atomically thin 2D MXene sheets provide adequate attacking sites for the protonated ligands, which could accelerate the reaction while preserving the underlying 2D topology.

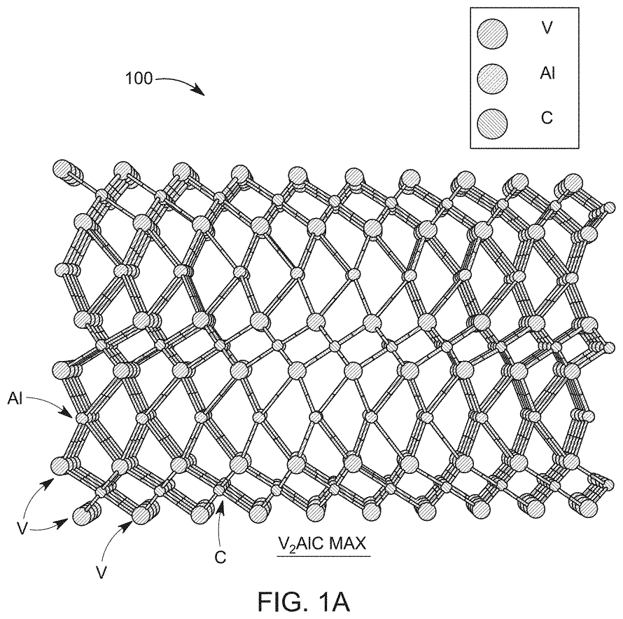

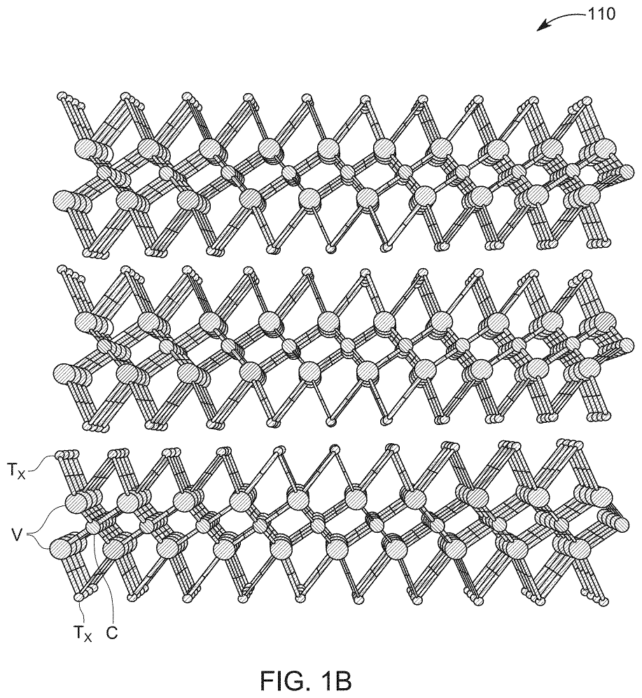

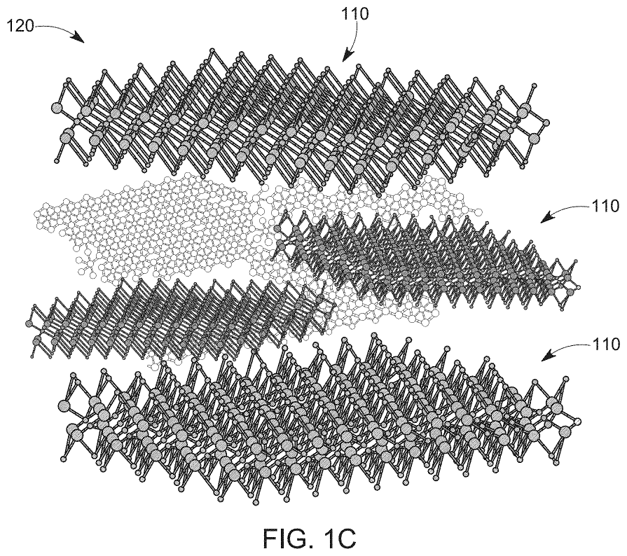

In one embodiment, a V₂CTₓ MXene and a H₂TCPP (H₂TCPP=meso-tetra(4-carboxyl-phenyl) porphyrin) ligand have been used to generate a novel MOF with 2D nanosheet morphology (V-MOF), which is an analog of Al-MOF [7]. The V₂CTₓ MXene was synthesized by immersing 1 g of V₂AlC MAX powder (300 mesh) compound 100, whose chemical structure is illustrated in FIG. 1A, into 20 ml HF (48%), and stirred at 35° C. for 24 h. This step removes the Al atoms by HF etching, as illustrated in FIG. 1B, which results in the formation of a multilayered V₂CTₓ structure 110. Then, the mixture was washed with deionized (DI) water and centrifuged (e.g., 3000 rpm) to collect the sediment. The washing procedure was repeated until the pH of the supernatant reaches about 6. For delamination, the as-etched sediment was immersed in 10 ml tetramethylammonium hydroxide (TMAOH, 1 M) and stirred for 4 h at room temperature. Subsequently, the supernatant was separated by centrifugation (8000 r.p.m) for two times to obtain a clay-like sediment. Finally, the delaminated V₂CTₓ MXene supernatant 120, whose chemical structure is illustrated in FIG. 1C, was collected by centrifugation (e.g., 4000 rpm). The concentration of the delaminated V₂CTₓ MXene 120 was calculated based on the mass of the film by vacuum filtration, which is about 2-3 mg/ml.

Then, a solvothermal method was employed to convert the V₂CTₓ MXene 120 and the ligand H₂TCPP 130 into the MOFs, based on the chemical interaction process illustrated in FIG. 2. The solvothermal method holds a precursor (the MXene) in a closed vessel in the presence of a solvent (e.g., dimethylformamide, DMF, or water) at a temperature higher than the boiling temperature of the solvent. The temperature at which the MOFs is fabricated, as discussed later, is between 120 and 180° C. for the selected MXene 120. As the vessel in which the MOF is manufactured is sealed, the pressure inside the vessel increases so that for a temperature between 120 and 180° C., the reaction taking place between the MXene and the binder would otherwise take place at about 800° C. in an open vessel. The H₂TCPP ligand 130 was selected because it contains a large planar aromatic ring 132 (porphyrin ring), which may show good topology compatibility with the 2D MXene. Moreover, the protons of four carboxylic groups 134 could provide attacking sites for binding the highly electronegative surface atoms of the MXene 120.

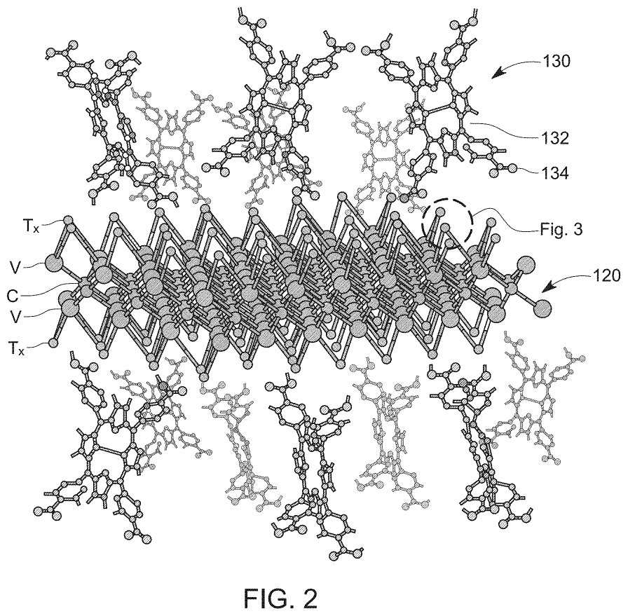

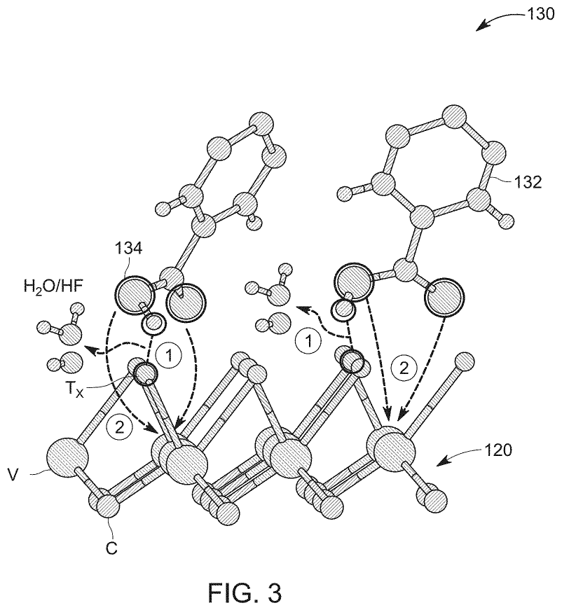

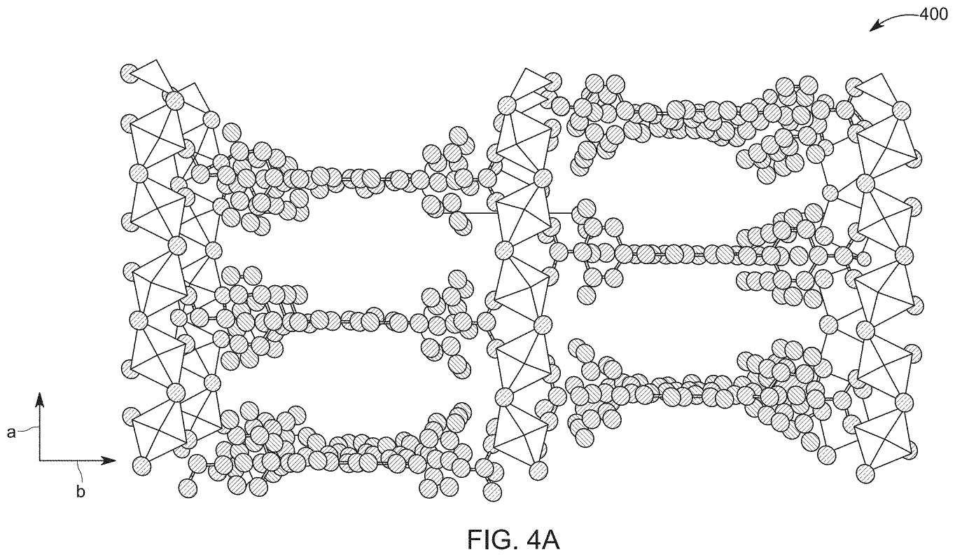

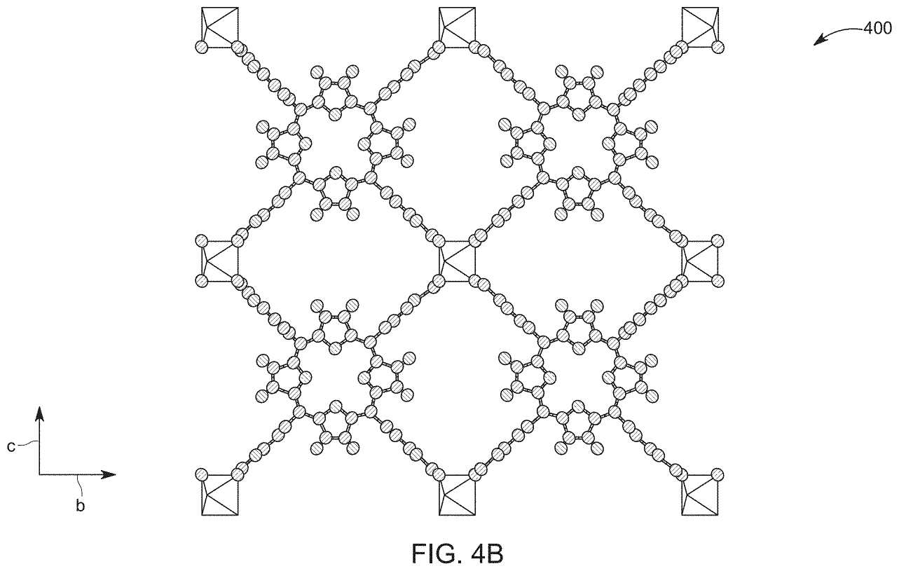

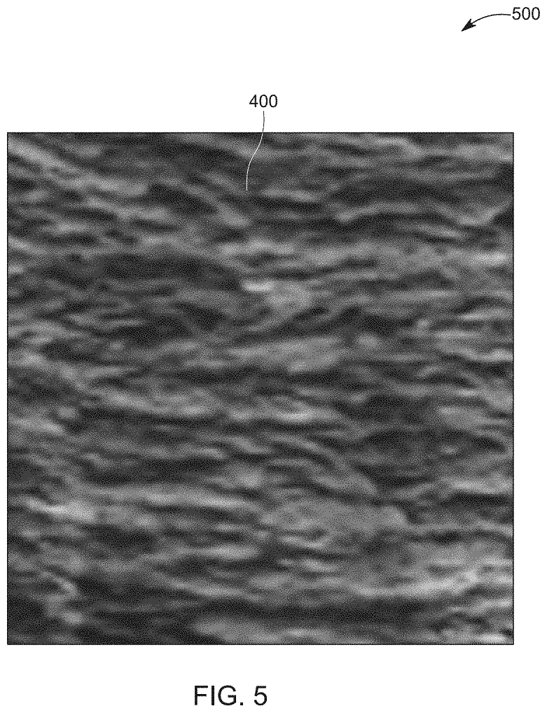

In this regard, FIG. 3 indicates by reference numeral 1 the deprotonation of the ligand 130 and the removal of the Tₓ, and indicates by reference numeral 2 the coordination reaction. Additionally, the N atoms embraced by the porphyrin core could serve as acceptors of hydrogen bonds to bridge guest molecules (e.g., nonvolatile H₃PO₄), which could afford MOFs with proton-conducting properties. The as-prepared V₂CTₓ-MOF nanosheets 400, which appear as a powdery substance to the naked eye, have a thickness of less than 20 nm, and a length of less than 100 nm, and are illustrated in FIGS. 4A and 4B along various axes. In one application, because the resulting V₂CTₓ-MOF nanosheets 400 are wet, a drying step is applied to remove the trace solvent from the final product. The V₂CTₓ-MOF nanosheets 400 can be stacked by spin coating, or other similar processes, to form oriented thin films 500, as illustrated in FIG. 5. Note that the plural V₂CTₓ-MOF nanosheets 400 are stacked substantially parallel to each other to form the thin film 500. The MOF thin film 500 may have a thickness T of less than 400 nm, or less than 300 nm, or less than 200 nm, or even less than 100 nm, while a length L of the film can be in the cm scale, e.g., about 10 cm. Such MOF thin films 500 when doped with the guest acid dopants show a high proton conductivity (σ) of 7.9×10⁻³ S cm⁻¹ at 25° C., which makes them promising for thin-film electronic, photonic, and sensor devices.

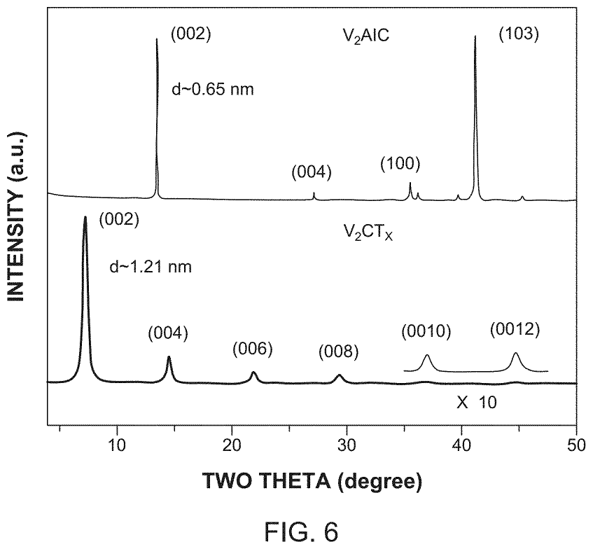

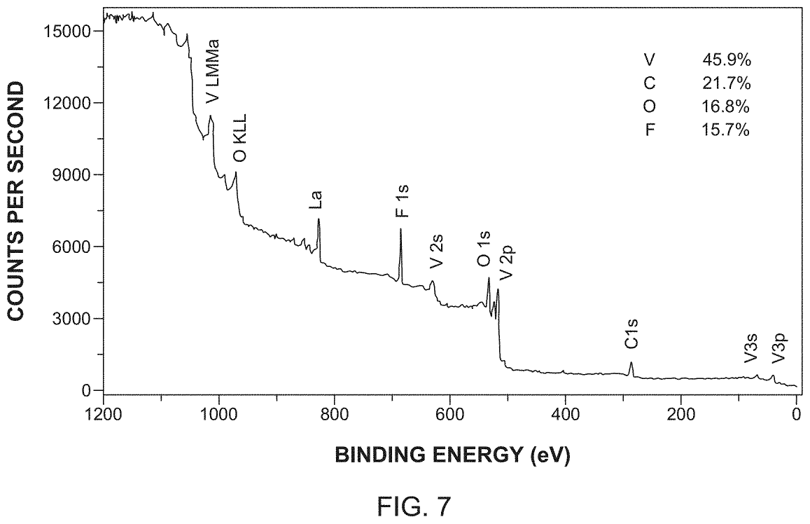

An accordion-like MXene nanostructure 120 was observed after etching the Al layers out of the densely packed MAX phase 100. The X-ray diffraction (XRD) pattern of the MXene 120, shown in FIG. 6, indicates that a layered feature is obtained after delamination, in accordance with previous results [8]. The corresponding interlayer spacing is found to be around 1.21 nm, which is much higher than its precursor MAX parent 100 (which is about 0.65 nm), demonstrating the successful synthesis of the 2D MXene material 120. Transmission electron microscopy (TEM) image reveals an ultrathin sheet-like morphology. High-resolution TEM (HRTEM) image and corresponding fast Fourier transform (FFT) pattern display the hexagonal symmetry of the MXene 120, perpendicular to the (0010) planes. Energy-dispersive X-ray (EDX) elemental mapping manifested that all elements are distributed homogeneously in the nanosheets. The thickness of the nanosheets detected by atomic force microscopy (AFM) is around 1.2 nm, implying the formation of V₂CTₓ monolayers. High-resolution X-ray photoelectron spectroscopy (XPS) analysis of the MXene was performed to investigate the terminal atomic bonding, as illustrated in FIG. 7. The atomic ratio of the elements was found to be V (45.9%) to C (21.7%), which is close to 2, in agreement with the stoichiometric proportion of the V₂CTₓ MXene 120. Quantitative terminal O (16.8%) and F (15.7%) atoms were further verified in the V₂CTₓ MXene material 120.

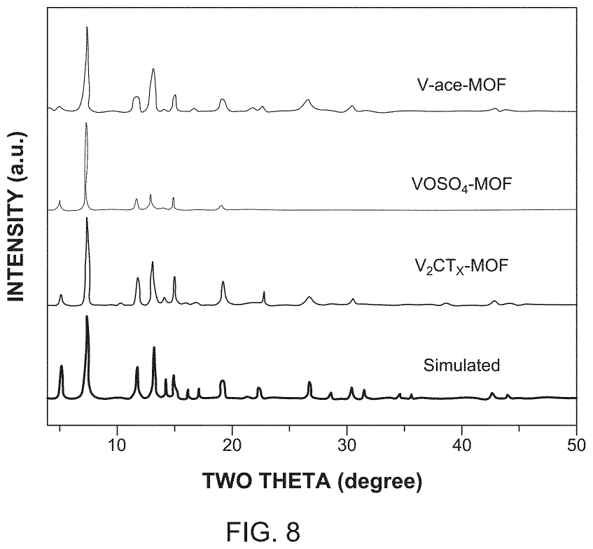

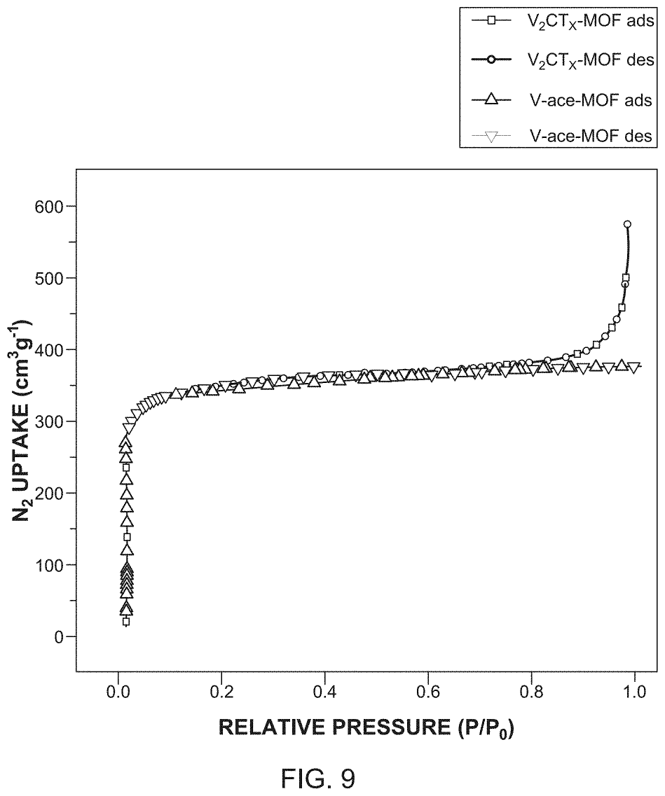

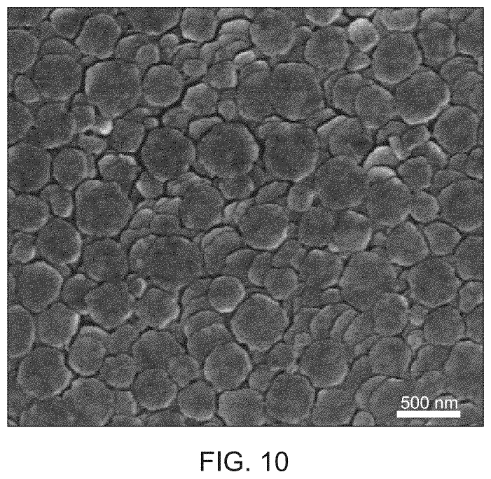

The feasibility of using V₂CTₓ MXene 120 as metal sources/precursor to synthesize MOFs 400 was confirmed by XRD, which is shown in FIG. 8, where the V₂CTₓ MXene-derived powder is in excellent agreement with the XRD of the simulated structure, as well as that when using VOSO₄ and vanadium acetate as the metal source reactants to obtain V-ace-MOF. The porosity of the V₂CTₓ-MOF 400 and V-ace-MOF were investigated and they exhibit a type-I nitrogen sorption isotherms, as illustrated in FIG. 9. The experimental Brunauer-Emmett-Teller (BET) surface areas are 1397 and 1357 m² g⁻¹ respectively, indicating the complete conversion of the MXene to MOFs. SEM of the V₂CTₓ-MOF displays a 2D sheet-like morphology with a lateral size ranging from one hundred to few hundreds of nanometers, as indicated in FIG. 10.

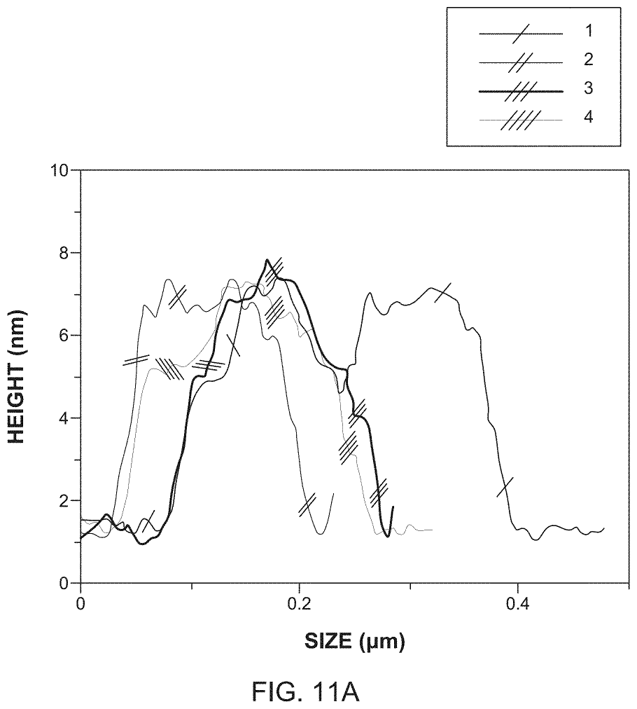

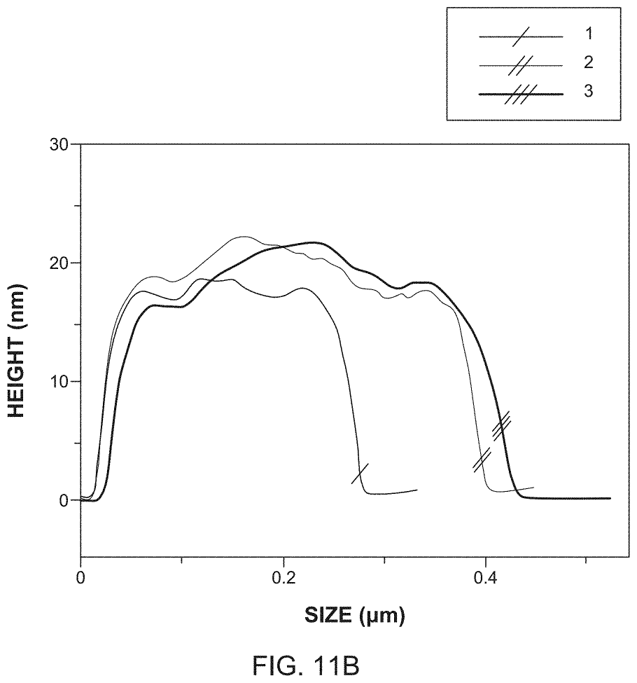

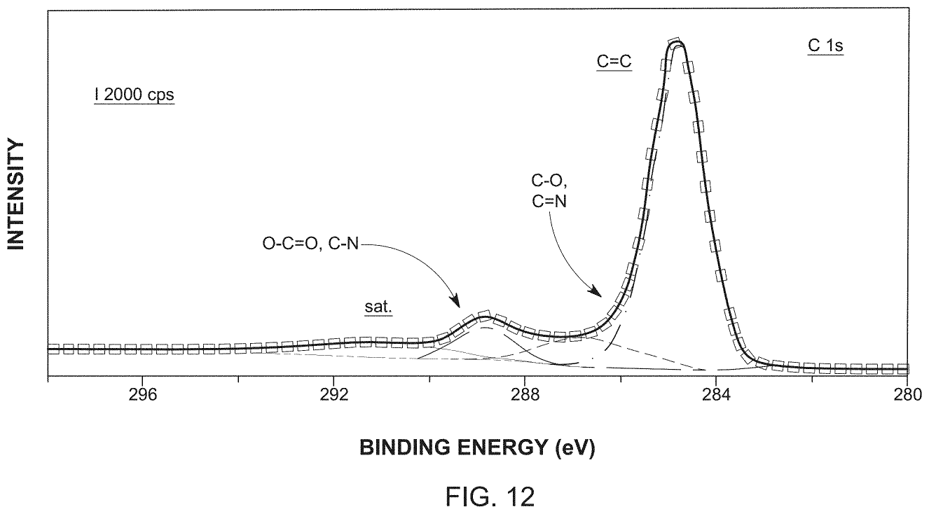

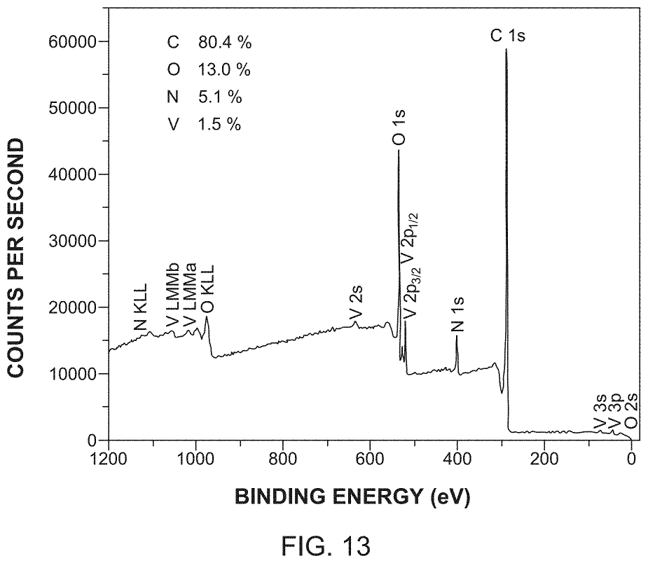

Meanwhile, the thickness of the V₂CTₓ-MOF sheets 400 can be tuned from 6 to 18 nm by varying the reaction temperature between the MXene 120 and the ligand 130, from 120 to 180° C. In this regard, FIG. 11A shows the change in height of various regions 1 to 4 of the V₂CTₓ-MOF sheets 400 at 120° C. and FIG. 11B shows the height of the same regions at 180° C. It is noted that by increasing the reaction temperature, the thickness of the MOF sheets increases, which indicates that by controlling the reaction temperature, a given thickness of the generated MOF can be achieved. In comparison, the VOSO4-MOF and V-ace-MOF show much larger spherical (>10 μm) and cubic (>2 μm) structures, respectively. The XPS analysis of the V₂CTₓ-MOF 400 shows that the bonds of MXene (V—C and V—F) have disappeared, while the aromatic C═C and C—O bonds originating from the TCPP ligands became dominant, as illustrated in FIG. 12. The atomic ratio of the N (5.1%) to V (1.5%) atoms is found to be 3.4, as illustrated in FIG. 13, suggesting 2.8 DMF solvent molecules per unit in the V₂CTₓ-MOF, which is consistent with previously reported results.

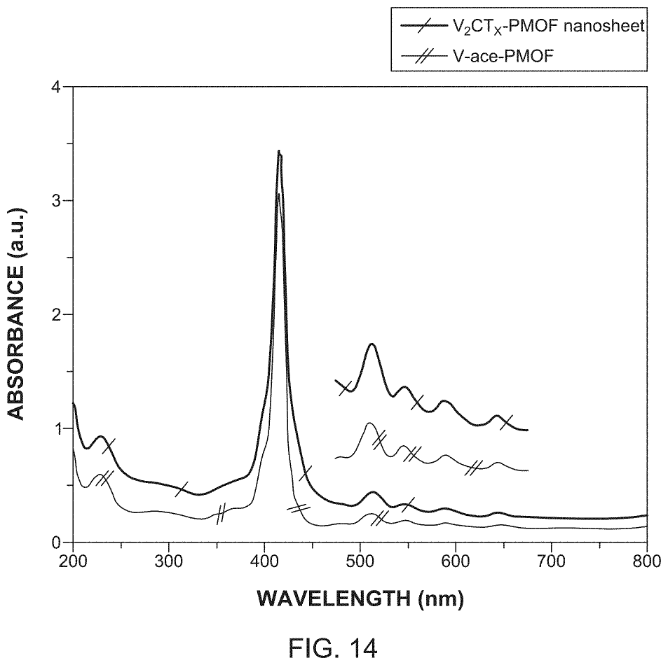

Moreover, two distinct peaks (C—NH and C═N—C) were deconvoluted from the N 1s spectrum, implying that no V was located at the center of the porphyrin rings. This was confirmed by the UV-visible absorption spectrum shown in FIG. 14, where four Q bands at lower binding energies are observed due to π-π* transitions in the free-base porphyrins. Additionally, Fourier transform infrared spectroscopy shows the N—H stretching vibration (3320 cm⁻¹) and in-plane vibration (964 cm⁻¹) peaks, further indicating non-metalated centers. More directly, the crystal structure of the V₂CTₓ-MOF nanosheets 400 was captured using low-dose HRTEM (by which the beam-sensitive structure could be imaged at the atomic level). The HRTEM image, which was taken along the </00> zone axis, shows that highly ordered cages are present, and the corresponding FFT image shows a cubic structural feature, both of which are consistent with the crystal structure of the V₂CTₓ-MOF 400. Moreover, the processed HRTEM images present a good match with the projected structural model and simulated results. Normally, it is highly challenging to capture the crystal structures of the MOFs at atomic resolution. The good preservation of the original crystal structure of the V₂CTₓ-MOF 400 implies its good stability. Thermogravimetric analysis reveals that the V₂CTₓ- MOF nanosheets are stable up to 350° C. in nitrogen atmosphere.

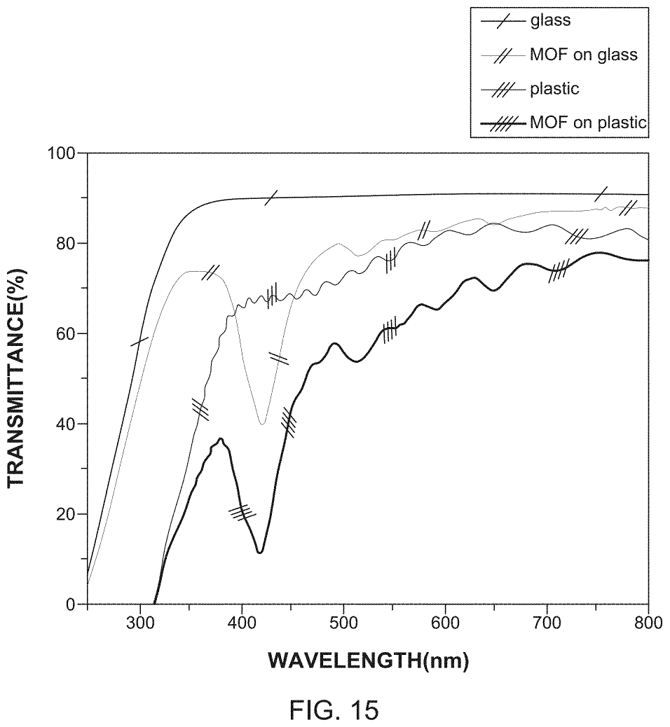

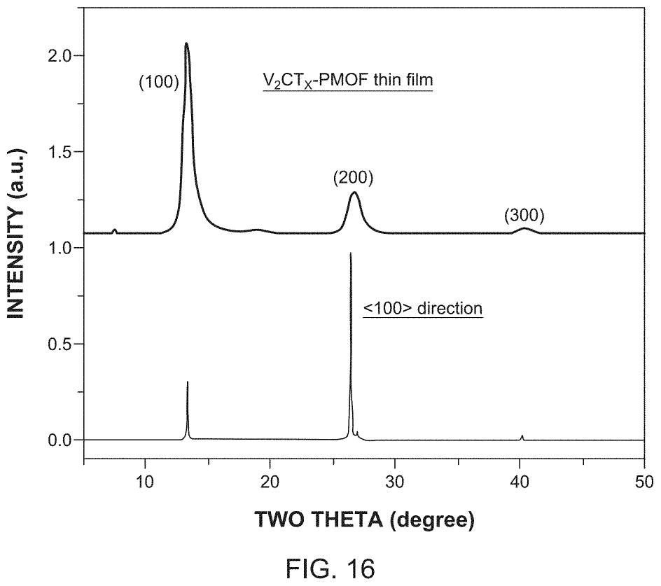

The nanosheet morphology of the synthesized V₂CTₓ-MOF 400 is suitable for forming thin films, which could open the door for many applications. A spin-coating strategy was adopted in one embodiment to fabricate MOF thin films using a colloidal suspension, for example, V₂CTₓ-MOF in methanol, 1 mg mL⁻¹. The MOF thin films can be constructed on both glasses and flexible plastic substrates with a root mean square roughness of about 9.5 nm and a thickness of about 20 nm while retaining good transparency. UV-vis transmission spectroscopy indicates that the thin films have an obvious peak at around 420 nm, in correspondence with the absorption spectrum, while a high transmittance (75% and 60%, respectively) after 500 nm is observed as noted in FIG. 15. Interestingly, the XRD of the thin film features sharp (100) peaks with almost no additional reflections, which fits with the simulated result along the <100>direction (see FIG. 16), indicating the highly oriented stacking of the V₂CTₓ-MOF thin film 500. Note that the fabrication of the MOF thin films (especially with a specific orientation) is rare and difficult. Such thin films are not achievable using MOFs derived from the other two precursors discussed herein, implying the uniqueness and superiority of the MXene-derived MOFs thin film 500.

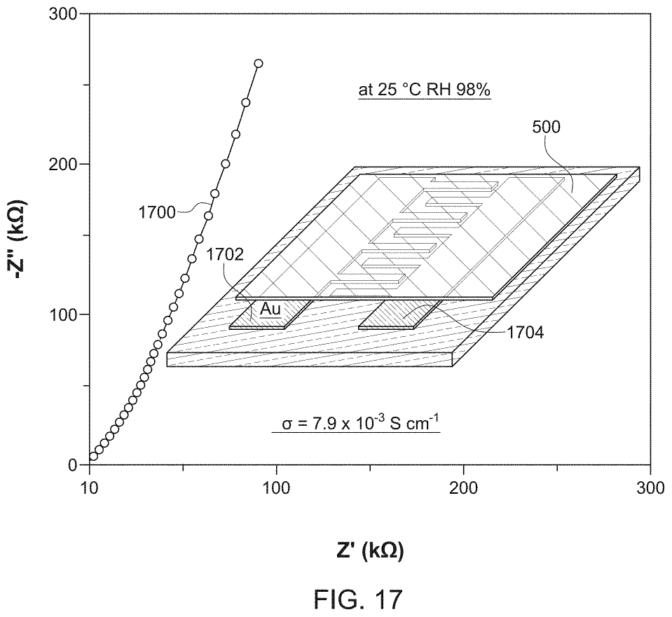

As the center of the porphyrin rings are not metalated, the inner N atoms could serve as acceptors of hydrogen bonds. Thus, nonvolatile H₃PO₄ enables the solid MOF thin films 500 with potent proton-conducting property by forming hydrogen bond networks within the MOFs. The protonation of the N atoms after acid impregnation can be confirmed by experimental tests and the red-shifted peaks of the Q bands in the UV-visible absorption spectrum shown in FIG. 14. Alternating-current impedance measurements represented by line 1700 were performed on the MOF thin film 500 using interdigitated electrodes 1702 and 1704 for the configuration 1700 illustrated in FIG. 17 and the proton conductivity was calculated to be 7.9×10⁻³ S cm⁻¹ , representing a very advantageous proton-conducting MOFs thin film.

A couple of applications of the novel V₂CTₓ-MOF thin film 500 are now discussed. A first application is related to the electrocatalytic CO₂ reduction reaction (CO₂RR) to form valuable liquid fuels (C₁ to C₃ products such as formic acid (HCOOH), ethanol, and n-propanol) using renewable energy is a potential strategy to achieve a carbon-neutral energy cycle. These liquid products were usually generated and mixed with solutes in the electrolyte of traditional H- or flow-cell reactors, which requires extra separation and concentration processes to recover pure liquid fuel solutions in practical applications. Taking CO₂RR to HCOOH as a representative example, while highly selective (>90%) and active catalysts have been presented in recent works, in most cases the products were actually in the form of formate due to the neutral or alkaline electrolyte environments, as well as in low concentrations. Similarly, the production of electrolyte-free C₂₊ liquid oxygenate solutions is still an open challenge. Therefore, to directly and continuously produce pure liquid fuel solutions, particularly with high product concentrations and long-term operation, is highly desired for the practical deployment of electrocatalytic CO₂RR.

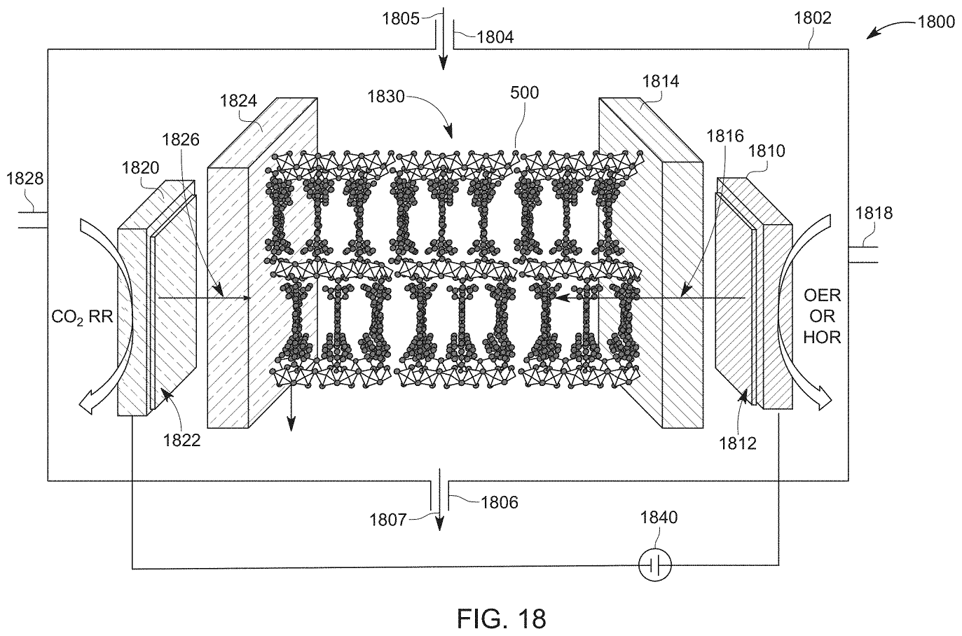

The inventors have found that the V₂CTₓ-MOF thin film 500 can be used as a solid-state electrolyte (SSE) in a CO₂RR system to produce electrolyte-free liquid products including HCOOH, acetic acid, ethanol, and n-propanol. According to an embodiment illustrated in FIG. 18, a cell 1800 has a housing 1802 having an inlet 1804 for receiving water or a gas 1805, and an outlet 1806 for collecting a fuel 1807. The cell 1800 also includes a cathode 1810 and an anode 1820, each of which includes a catalyst-coated gas diffusion layer (GDL) electrode. The catalyst 1822 may include Bi, Co, Pd, In, Pb, Sn and a carbonaceous material while the catalyst 1812 may include IrO₂—C. The cathode 1810 and the anode 1820 are separated by anion and cation exchange membranes (AEM 1824 and CEM 1814), respectively, from the solid state electrolyte, which is the V₂CTₓ-MOF thin film 500 in this embodiment. Note that other thin films made from an MXene may be used in the cell 1800 as the solid state electrolyte 1830. The thin film 500 was placed in between the membranes 1814 and 1824 with close contact to efficiently transport the generated ions and significantly minimize the ohmic loss of the entire device.

When the CO₂ supplied at the cathode 1820, through port 1828, is reduced by a HCOOH-selective catalyst, the generated negatively charged HCOO− 1826 is driven by the electrical field, which is generated between the cathode and the anode when an electrical current is applied by a power source 1840, and the HCOO− 1826 travels through the membrane 1824 towards the middle solid-electrolyte channel. At the same time, protons 1816 generated by water oxidation (the water is supplied at port 1818 or is shared from the inlet 1804, and oxygen evolution reaction, OER, or hydrogen oxidation reaction, HOR, generates the proton from the water) on the anode side can move across the membrane 1814 to compensate the charge. Depending on the type of solid ion-conducting electrolyte 1830 in between, the HCOOH product 1807 could be formed via the ionic recombination of crossed ions at either the left (H+-conductor) or right (HCOO−-conductor) interface between the middle channel and membrane, and diffuse away through the liquid water to the output 1806. Then, the formed liquid products can be quickly released by the slow deionized water stream or humidified inert gas flow. Pure HCOOH solution with a wide range of concentrations can be produced by adjusting the flow rate of the deionized water or gas 1805.

In another application, the V₂CTₓ-MOF thin film 500 can be used in iontronics applications, as this material shows high quality, chemical stability, and capability to support standard device patterning processes, e.g., dry etching, optical beam lithography, electron beam lithography. lontronics is a recently emerging interdisciplinary concept, which is based on an electrochemical transistor platform using a gate electric field to control the interaction between ionic and electronic transport behaviors. One of the possible device architectures is the electric double-layer (EDL) transistor. The EDL is formed at the interface between an electrolyte (ionic conductor) and a semiconductor (electron conductor) when an electric field is applied to the gate electrode. During the EDL formation, the electronic current flowing through the semiconductor could be modulated. The inventors have discovered that the MOF solid-state film 500 can be used as an ionically conductive electrolyte in the EDL transistors.

The fabrication process of a MX-MOF (MXene based MOF)/MoS₂ EDL transistor is now discussed. The V₂CTₓ MXene 120 discussed above, having atomically thin 2D vanadium carbide with surface functional groups Tₓ (—F, —OH, and ═O), was utilized as the metal source and soft template for the synthesis of the MX-MOF 2D nanosheets 400. Using the MXene and commercial H₂TCPP (H₂TCPP=meso-tetra(4-carboxyl-phenyl)porphyrin) ligand, the 2D MX-MOF nanosheets 400 were synthesized by using a hydrothermal method. After purification, these nanosheets were dispersed in methanol as a stable suspension. The liquid sample shows a red-violet color, with a concentration of 1 mg/mL (MX-MOF weight/methanol volume). This suspension was used to form the high-quality uniform MX-MOF films 500 by spin-coating.

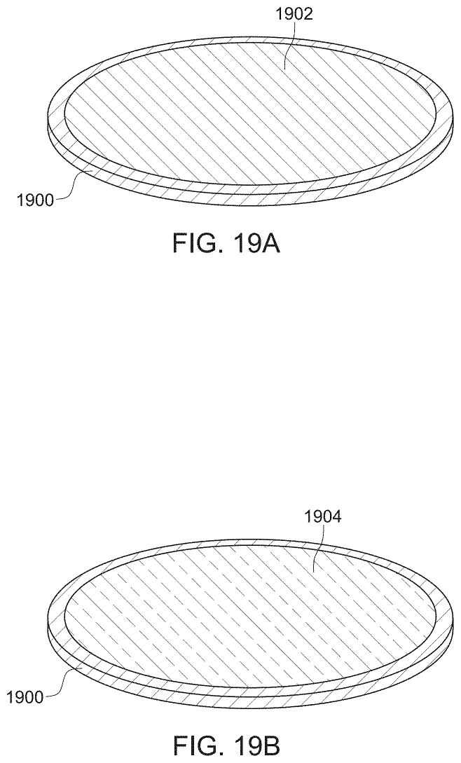

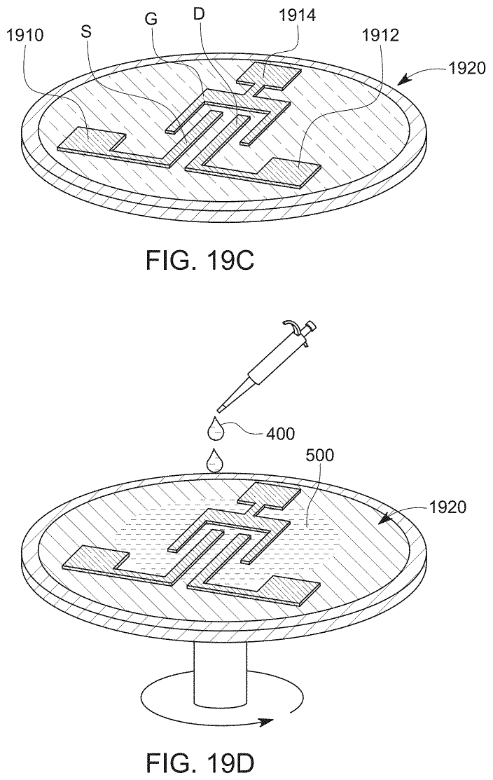

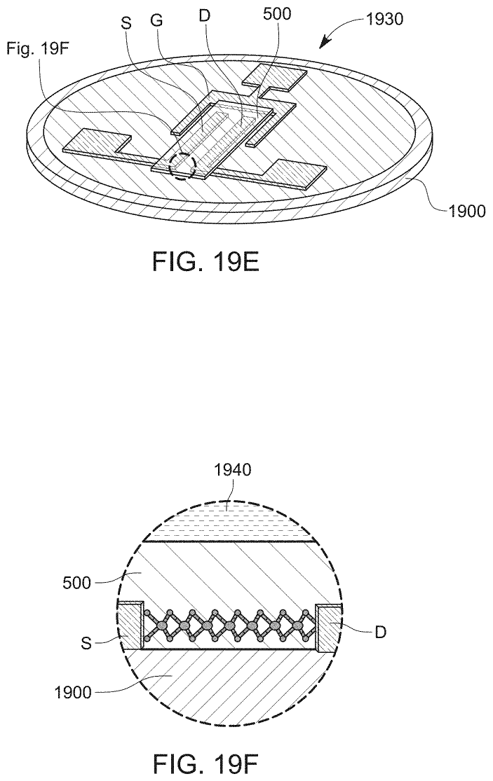

FIGS. 19A to 19F illustrate how the EDL transistor 1930 was prepared. A MoO₂ precursor film 1902 (Epi-MoO2) was epitaxially grown on a sapphire substrate 1900 by pulsed laser deposition, as shown in FIG. 19A. Through a high-temperature sulfurization process, continuous high-quality epitaxial MoS₂ (Epi-MoS2) films 1904 were obtained, which are uniform and continuum. The MoS₂ film 1904 was patterned through a dry etching process, and source/drain (S/D) and gate G regions were formed, and corresponding contacts and side-gate Au/Ti electrodes 1910, 1912, and 1914 were patterned through a lift-off process, to form semifinished device 1920, as illustrated in FIG. 19C. The source and drain may be made from a semiconductor material. Then, the MX-MOF nanosheets 400 were spin-coated on the entire semifinished device 1920, from a methanol-based MX-MOF suspension, to cover the source S, the drain D, and the gate G, as illustrated in FIG. 19D. The MX-MOF film 500 thickness was controlled by the spin-coating time. The transistor 1930 after MX-MOF film 500 patterning is shown in FIG. 19E, with FIG. 19F shows a cross-section through the transistor.

An attractive feature of this device fabrication process is that the MX-MOF film 500 can be processed through conventional photolithography and dry etching without degradation. The EDL transistor 1930 can be permanently capped with a photoresist layer 1940 after the MX-MOF patterning to keep the stable ionic transport environment within the MX-MOF layer 500. After H₃PO₄ acid treatment for a certain time, the functioning MX-MOF/MoS₂ EDL transistor is finally obtained.

The MX-MOF film 500 is also compatible with standard lithography processes. In this regard, the compatibility of the MX-MOF films with the standard lithography process was evaluated by exposing the film 500 to the chemicals involved in a typical cleanroom fabrication processes. In one experiment, the freshly prepared MX-MOF film 500 was exposed to acetone, isopropanol, DI water, and AZ726 developer solution for 2 min, followed by blow-drying under a nitrogen gun. The MX-MOF film 500 did not exhibit any clear degradation (demonstrated by XRD characterization and digital photos) due to this treatment. In one experiment, the MX-MOF film 500 was placed in acetone and separately in chloroform solutions for 5 h at a holding temperature of 80° C., and the MX-MOF film still retained its pristine morphology. The above experiments demonstrate that the MX-MOF films 500 have sufficient chemical stability for the standard electronic device fabrication processes. Using the UV-light photolithography and plasma-dry-etching process, the inventors successfully patterned the MX-MOF film 500 to have various shapes. The obtained samples show sharp pattern edges indicating the ability to pattern the MX-MOF film by UV photolithography with several-micrometer resolution. In another test, the MX-MOF film was patterned in the form of circle arrays. The specific enlarged single circle pattern indicates that the morphology of the MX-MOF-nanosheet film is well retained. Electron-beam lithography (EBL) was also used to demonstrate the capability to pattern the novel MX-MOF film 500. The optical and SEM images of MX-MOF EBL patterns demonstrate that using the EBL technique to pattern MX-MOF films it is possible to use these materials in nanoelectronics.

Thus, the developed MX-MOF nanosheets 400 find wide applications in multiple fields. The highly electronegative terminal atoms and adequate accessible surfaces of the MXene used to generate the MOF films enable the topological synthesis and fabrication of the MOFs with 2D nanosheet morphology. The as-prepared MOF with 2D nanosheets with tunable thickness could be stacked in a specific orientation to form thin films. The MOF thin films exhibited exceptional uniformity, which is superior to previously reported MOF thin films. The V₂CTₓ-MOF exhibited appealing proton conductivity with acid impregnation, which is promising for electronic, sensing, and electrochemical applications.

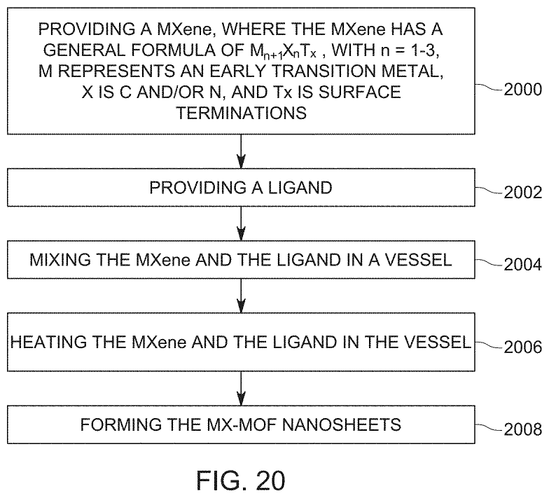

A method for making the MOF nanosheets 400 into a MOF film 500 that has substantially a parallel distribution of the MOF nanosheets 400 is now discussed with regard to FIG. 20. The method includes a step 2000 of providing the MXene 120, where the MXene 120 has a general formula of Mₙ₊₁XₙTₓ, with n=1-3, M represents an early transition metal, X is C and/or N, and Tₓ is surface terminations, a step 2002 of providing the ligand 130, a step 2004 of mixing the MXene 120 and the ligand 130 in a vessel, a step 2006 of heating the MXene 120 and the ligand 130 in the vessel, and a step 2008 of forming the MX-MOF nanosheets 400, where the MX-MOF nanosheets 400 have a thickness less than 10 nm. In one application, the MXene is V₂CTₓ and the ligand is H₂TCPP. The step 2000 may include, for example, placing 10 mg of the MXene 120 into a 10 ml of the DMF solvent and dispersing the MXene by sonication. The step 2004 may include mixing the above solution with 150 mg of TCPP followed by a 10 minutes sonication process. The step 2008 includes a heating of about 4 h of the mixture, for example, in an autoclave that is sealed. Then, the mixture is left to cool down to room temperature naturally. The precipitate is collected in step 2008 by centrifugation, for example, at 11 rpm, followed by a step of solvent-exchange with methanol for about 24 h. Then the obtained powder is dried under vacuum at room temperature to obtain the MX-MOF nanosheets 400. The details steps presented herein for forming the MX-MOF nanosheets 400 are to enable one skilled in the art to make this invention. However, those skilled in the art should understand that slight deviations from the above parameters, for example, not more than 20 to 30%, would not alter the qualities of the formed MX-MOF nanosheets 400.

The method may further include a step of adding a solvent in the vessel before the heating step, and/or a step of sealing the vessel before the heating step. The step of heating comprises heating between 120 and 180° C. The method may further include a step of drying the MX-MOF nanosheets. In one embodiment, M is Ti or V, X is C and/or N, and Tₓ is —F, —O and —OH. The method may further includes a step of spin coating the MX-MOF nanosheets on a substrate to form a MX-MOF film having a thickness less than 400 nm, and/or a step of impregnating the MX-MOF nanosheets with a non-volatile acid to enable proton-conducting properties in the MX-MOF nanosheets.

In one application, the method may also include placing the MX-MOF nanosheets, in solid state, between a cathode and an anode of a cell, supplying CO₂ to the cell, and applying electrical energy between the cathode and anode to transform the CO₂ into fuel. In another embodiment, the method may further include a step of applying the MX-MOF nanosheets between a source, a drain, and a gate deposited on a substrate to form an electric double-layer (EDL) transistor, where the EDL is formed at an interface between a ionic conductor and a semiconductor, where the MX-MOF nanosheets are the ionic conductor and the drain and gate are the semiconductor.

The disclosed embodiments provide a method for manufacturing a MOF thin film based on a MXene. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### References

[1] Makiura, R.; Motoyama, S.; Umemura, Y.; Yamanaka, H.; Sakata, O.; Kitagawa, H. Surface Nano-architecture of a Metal-Organic Framework. Nat. Mater. 2010, 9, 565-571.

[2] Motoyama, S.; Makiura, R.; Sakata, O.; Kitagawa, H. Highly Crystalline Nanofilm by Layering of Porphyrin Metal-Organic Framework Sheets. J. Am. Chem. Soc. 2011, 133, 5640-5643.

[3] Liu, J.; Shekhah, O.; Stammer, X.; Arslan, H. K.; Liu, B.; Schübach, B.; Terfort, A.; Wöll, C. Deposition of Metal-Organic Frameworks by Liquid-Phase Epitaxy: The Influence of Substrate Functional Group Density on Film Orientation. Materials 2012, 5, 1581-192.

[4] Moreno-Moreno, M.; Troyano, J.; Ares, P.; Castillo, O.; Nijhuis, C. A.; Yuan, L.; Amo-Ochoa, P.; Delgado, S.; Gomez-Herrero, J.; Zamora, F.; Gomez-Navarro, C. One-Pot Preparation of Mechanically Robust, Transparent, Highly Conductive, and Memristive Metal-Organic Ultrathin Film. ACS Nano 2018, 12, 10171-10177.

[5] Pustovarenko, A.; Goesten, M. G.; Sachdeva, S.; Shan, M.; Amghouz, Z.; Belmabkhout, Y.; Dikhtiarenko, A.; Rodenas, T.; Keskin, D.; Voets, I. K.; Weckhuysen, B. M.; Eddaoudi, M.; de Smet, L.; Sudholter, E. J. R.; Kapteijn, F.; Seoane, B.; Gascon, J. Nanosheets of Nonlayered Aluminum Metal-Organic Frameworks through a Surfactant-Assisted Method. Adv. Mater. 2018, 30, 1707234.

[6] Virmani, E.; Rotter, J. M.; Mahringer, A.; von Zons, T.; Godt, A.; Bein, T.; Wuttke, S.; Medina, D. D. On-Surface Synthesis of Highly Oriented Thin Metal-Organic Framework Films through Vapor-Assisted Conversion. J. Am. Chem. Soc. 2018, 140, 4812-4819.

[7] Fateeva, A.; Chater, P. A.; Ireland, C. P.; Tahir, A. A.; Khimyak, Y. Z.; Wiper, P. V.; Darwent, J. R.; Rosseinsky, M. J. A Water-Stable Porphyrin-Based Metal-Organic Framework Active for Visible-Light Photocatalysis. Angew. Chem. Int. Ed. 2012, 51, 7440-7444.

[8] VahidMohammadi, A.; Mojtabavi, M.; Caffrey, N. M.; Wanunu, M.; Beidaghi, M. Assembling 2D MXenes into Highly Stable Pseudocapacitive Electrodes with High Power and Energy Densities. Adv. Mater. 2019, 31, 1806931.

1. A method for making a metal-organic framework, MOF, as nanosheets, the method comprising:
providing a MXene, wherein the MXene has a general formula of Mₙ₊₁XₙTₓ, with n=1-3, M represents an early transition metal, X is C and/or N, and Tₓ is surface terminations;
providing a ligand;
mixing the MXene and the ligand in a vessel;
heating the MXene and the ligand in the vessel; and
forming the MX-MOF nanosheets,
wherein the MX-MOF nanosheets have a thickness less than 10 nm.

2. The method of claim 1, wherein the MXene is V₂CTₓ.

3. The method of claim 2, wherein the ligand is meso-tetra(4-carboxyl-phenyl) porphyrin), H₂TCPP.

4. The method of claim 3, further comprising:
adding a solvent in the vessel before the heating step.

5. The method of claim 4, further comprising:
sealing the vessel before the heating step.

6. The method of claim 5, wherein the step of heating comprises heating between 120 and 180 ° C.

7. The method of claim 6, further comprising:
drying the MX-MOF nanosheets.

8. The method of claim 1, wherein M is Ti or V, X is C and/or N, and Tₓ is —F, —O and —OH.

9. The method of claim 1, further comprising:
spin coating the MX-MOF nanosheets on a substrate to form a MX-MOF film having a thickness less than 400 nm.

10. The method of claim 1, further comprising:
impregnating the MX-MOF nanosheets with a non-volatile acid to enable proton-conducting properties in the MX-MOF nanosheets.

11. The method of claim 1, further comprising:
placing the MX-MOF nanosheets, in solid state, between a cathode and an anode of a cell;
supplying CO₂ to the cell; and
applying electrical energy between the cathode and anode to transform the CO₂ into fuel.

12. The method of claim 1, further comprising:
applying the MX-MOF nanosheets between a source, a drain, and a gate deposited on a substrate to form an electric double-layer (EDL) transistor,
wherein the EDL is formed at an interface between an ionic conductor and a semiconductor, where the MX-MOF nanosheets are the ionic conductor and the drain and gate are the semiconductor.

13. An electrochemical cell, comprising:
a housing;
an anode located inside the housing;
a cathode located inside the housing; and
a solid state electrolyte located between the anode and cathode, the solid state electrolyte including a MXene based metal-organic framework, MX-MOF, film,
wherein the MX-MOF film includes parallel distributed MX-MOF nanosheets.

14. The electrochemical cell of claim 13, wherein the MXene is V₂CTₓ.

15. The electrochemical cell of claim 13, wherein the housing comprises:
an input for receiving water or a gas;
a port for receiving CO₂; and
an output where the fuel is collected.

16. The electrochemical cell of claim 13, further comprising:
a first membrane located between the cathode and the MX-MOF film; and
a second membrane located between the anode and the MX-MOF film.

17. The electrochemical cell of claim 13, wherein the cathode is coated with a first catalyst that promotes formation of carbon based ions and the anode is coated with a second catalyst that promotes formation of protons.

18. A transistor comprising:
a substrate;
a semiconductor layer formed on the substrate and patterned to form a source S, a drain D, and a gate G;
a MXene based metal-organic framework, MX-MOF, film formed over the source S, drain D, and gate G; and
an encapsulation layer formed over the MX-MOF film to confine an ionic transport environment within the MX-MOF film.

19. The transistor of claim 18, wherein the MXene is V₂CTₓ.

20. The transistor of claim 18, wherein the MX-MOF film includes parallel distributed MX-MOF nanosheets.
